(19) United States
(12) Patent Application Publication
(10) Pub. No.: US 2017/0286999 A1
(43) Pub. Date: Oct. 5, 2017

(54) PERSONAL DEVICE-ENABLED LIFESTYLE, COMMERCE AND EXCHANGE TRACKING SYSTEM

(71) Applicant: Frank Nemirofsky, Alamo, CA (US)

(72) Inventor: Frank Nemirofsky, Alamo, CA (US)

(21) Appl. No.: 15/626,351

(22) Filed: Jun. 19, 2017

Related U.S. Application Data
(63) Continuation of application No. 14/217,081, filed on Mar. 17, 2014, now abandoned.

(51) Int. Cl. G06Q 30/02

(52) U.S. Cl. CPC G06Q 30/0251; G06Q 30/0201

(57) ABSTRACT

In one embodiment, a system and method include receiving user information data from a personal electronic device. The user information data includes information about a user using the personal electronic device. The server stores user information data and receives action data from the personal electronic device. The action data includes information relating to an object captured through the personal electronic device. The object captured may include an embedded signal such as a bar code, QWERTY code, fingerprint, watermark, and/or Ribbon®. The server generates and sends coupon, promotion, and/or information with respect to the embedded signal. The server receives redemption information with respect to an item represented within embedded signal.

### RELATED APPLICATIONS

This application is related to and hereby claims the priority benefit of U.S. Provisional Patent Application No. 61/800,580 filed on Mar. 15, 2013, and entitled “PERSONAL DEVICE-ENABLED LIFESTYLE, COMMERCE AND EXCHANGE TRACKING SYSTEM”, which application is incorporated herein by reference in its entirety.

### TECHNICAL FIELD

The present disclosure relates generally to a personalized information directed media, content and resulting commerce and post commerce tracking and analytics system, and, more particularly to tracking embedded signals captured by an electronic device.

### BACKGROUND

Television Networks and Television Cable companies, such as CBS™, NBC™ and Turner Broadcasting System, Inc, sell advertising at different rates for existing programming based on for example Nielsen Ratings™. The commercial slots for programs with the highest Nielsen Ratings™ are sold for more money than the shows with lower Nielsen Rating™ However, Nielsen Ratings™ only use a small sample of all households with televisions to determine their ratings of each television show.

Generally to determine the viewership of television shows, Nielsen Ratings™ require a set top box, which is connected to a television. The set top boxes are only placed in a sample of all the households in a country that have a television (CRT technology (cathode ray tube), flat-panel TVs using LCD, plasma or LEDs, Ultra HD 4K TV and other television delivery technologies. The sample is aimed at matching the current census; however there have been many complaints over time that minorities are underrepresented in these samples of household selected and the resulting data that is accumulated. For example, Spanish only networks believe their viewership is higher than the ratings received from Nielsen Ratings™. Also, Nielsen Ratings™ are limited by only using a sample of users, as sometime a show may have 0.0 rating, but the show has some viewership. Additionally, other indices about commerce are not possible through Nielsen™ such as commerce information such as what does a Spanish Language viewer of the same age group for example 18-34 females spend on the same advertised product as a white female 18-34 viewer spends on the same advertised product.

Furthermore, a company, for example Pepsi™, needs to determine that the advertisement that the company paid for was actually broadcast or played during that time period or page of a certain television program, radio program or newspaper. To verify advertisement placement, the company needs to pay another company, an ad verification company, to ensure the advertisement was aired during the time slot they bought from for example a television, radio or print network or within a specified television, radio or printed publication.

Additionally, the company would like to know buyer information about who used a coupon to buy a certain product or which individual buyers responded to an advertisement. However from a printed coupon, learning information about the buyer may be cumbersome, limiter, and/or expensive. For example, the buyer may have to fill out an information portion or buy/receive information from store where the buyer uses a store rewards/loyalty card with the coupon for a rewards/loyalty card that includes information about the user. However, the store may not track coupons within the buyer's store cards or may not offer the data for sale. Also, the store may not include demographic information about each buyer in their store card program.

### SUMMARY

The system generates accurate analytics of users daily watching reading, listening, gaming, wellness, commerce, exchange, cognitive and lifestyle and other activity. Furthermore, verifies that any and all content delivered through media. Additionally, verifying any and all content and the up to approximately 20,000 daily advertisements we choose to knowingly absorb or are subliminally influenced to provide in the future measurement and analysis of how the individual may react to the stimulus from the point of original stimulus, even the subliminal. The smart device assists in reacting to the human choice to accept or the human decision to accept at a future time or to have set in motion the acceptance at a time past. The source of the stimulus can be a host of signals including media, interactive media, content, interactive content, advertising, interactive advertising, targeted media, targeted human and animal wearable's, interactive human and animal internal, nano-medial devices and fluids and any other stimulus that sends data of any sort that can be measured and analyzed. The analysis can be for commercial return on investment, analysis of commercial information that will have an effect on a decision effecting a product brand, service. Additionally the analysis can be for wellness purposes including diagnosis, treatment and or medical research. There invention is a global means of measuring all stimulus from the tracking of human daily activity with the goal of understanding individuals choices and wellness among other daily activities so that the individual can be reported upon singularly or by groups of all manner of definitions.

A system and method in which a user's smart personal device is purposed to enable individual or cumulative tracking and facilitation of that user's lifestyle, commerce and exchange.

For tracking purposes, the system employs information obtained through the device's sensors, originating both from user selection of items (from media streams and also from items encountered in the real world) and from hidden information embedded in these items, as well as from background monitoring of user activities and behaviors.

From the user's perspective, facilitation occurs in three ways. First, the system uses the tracking data to create analytics that enable targeted content delivery and/or suggestions to the user. Second, the user's device is also purposed for payment and offer redemption at the point of sale (POS), with tracking also occurring during these transactions. Third, the user has access to the data and analytics for use in wellness, time management, participation in behavioral research studies, social sharing and other activities. Facilitation also occurs from the perspective of other stakeholders, because analytics obtained are offered to these stakeholders, subject to the privacy settings each user chooses. Additionally analytics can be combined from multiple users in certain categories or data retrieved based on when, who, and/or where the item is selected or captured.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates of a lifestyle/commerce tracking network;

FIG. 2 illustrates an example server;

FIG. 3 illustrates an example procedure for a personal device to capture and use an embedded signal;

FIGS. 4A and 4B illustrate an example procedure for the server to process an embedded signal;

FIG. 5 illustrates an example of stored history information for a user; and

FIG. 6 illustrates an example procedure for tracking an embedded signal in an advertisement.

### DETAILED DESCRIPTION

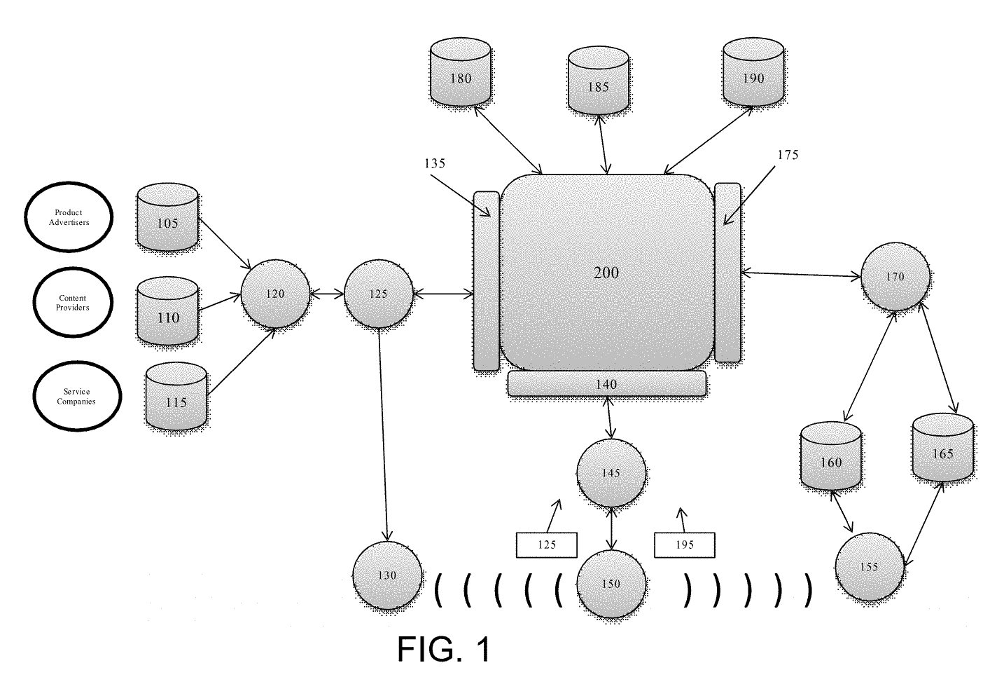

FIG. 1 is a schematic block diagram of an example lifestyle/commerce tracking network 100. The central database server 200 connects through an issuing interface 135 to supply an embedded signal 125 to an embedded signal encoder 120. The embedded signal 125 may include block based code (audio and/or video), watermarking (audio and/or video), fingerprinting, combination of block based code and watermarking, combination of block based code and fingerprinting, and/or a Ribbon™. Additionally, each embedded signal 125 may provide the location of where content is to be displayed such as NBC or a specific NBC affiliate network or a name of a publication. Each created embedded signal 125 and any relevant information may be stored within an embedded signal database 180. The embedded signal may include data, time, market, and/or anything creative team wants to include. For example, a marketing team may want to compare two different versions of the same ad, except each add has a different embedded signal to allow direct comparison of effect. The embedded signal is a pointer into a database.

The embedded signal encoder 120 receives advertisement (Ad) data 105 from product advertisers, content data 110 from content providers, and/or service data 115 from service companies. Product advertisers may be Coke™, Pepsi™, Ford™, or any other company with a product or service to advertise. Content providers may be any television network, print publications, billboard owners, internet network, etc. For example content providers may include TV networks such as Fox™ and/or Bravo™, but also may include streaming services such as Netflix™ and/or YouTube, and/or printed publication such as Times™ Magazine and/or NY Times™. Service companies may include bank cards.

The embedded signal encoder 120 generates embedded signal media 130 from the embedded signal 125 supplied by the central database server 200 and the Ad data 105, content data 110, and/or service data 115. The embedded signal media 130 may be any type of media including but not limited to television advertisements, internet advertisements, billboards, radio advertisements, newspaper advertisements, and circulars. Additionally, the embedded signal media 130 may provide additional information to the user about the media, such as athlete in a sporting program, a music video for a song on the radio, a cartoon video from a printed comic strip.

The user interacts with the personal device 150 using video capture, speech/text interface, and gesture and/or visual selection of items in the world. These items include all media, including but not limited to: television and video of all screen types, second screen, radio/audio, print, online, mobile web, social, gaming, and any other interactive content/interactive/targeted advertising. Within these media, a hidden or in some cases perceptible channel of auxiliary tracking information (e.g., time/place of broadcast), an embedded signal 125, can also be transmitted, via 1-D bar code, 2-D bar code, block based code (audio and/or video), watermarking (audio and/or video), fingerprinting, combination of block based code and watermarking, combination of block based code and fingerprinting, combination of, block-based coding and watermarking and fingerprinting, Near Frequency Communication (NFC), Short Message Service (SMS), and many others.

Additionally, the user's smart device 150 also includes Point of Sale (POS), bricks and mortar or virtual, presentment/settlement and other financial capabilities such as financial services embodied in bank accounts, credit lines, credit debit, stored value connected to plastic cards. Using personal device 150 interacting with a POS, server 200 can individually or cumulatively track data, commerce, exchange, and other individualized information using purchase information obtained from the user, user's device and/or merchant.

Additionally, individually and grouped targeted advertising is grouped based on the user or group of users with respect to psychographic, demographic, purchase history(s), preference(s), viewing, listening and reading habits, WOM (word-of mouth measurement), wellness, location, travel, and/or other models. Different models or groups can be formed in separate situations for separate analytics depending on the requirements of the client. The models may be for commerce, wellness, and/or any other analytical purpose.

Analytics are enriched considerably because of the frequent and often constant proximity to the user of personal devices 150 such as smart-phones, since they typically make available other sensor streams that can capture useful data about the user's patterns of life and responses to specific stimuli during the user's bricks & mortar excursions (GPS, accelerometers) as well as during media consumption at home (video/audio capture of facial/voice responses). These streams can be obtained passively (unobtrusively and automatically, with the consent of the user) or by smart device-enabled user capture, selection and/or highlighting of specific items found through the course of media consumption and/or interaction with the day-to-day environment.

For example, behavior data in a store may be analyzed based on speed and/or locations within a store from using sensors within the personal device including accelormaters, GPS, video, and/or audio. Additionally, behavior data may come from sensors on and/or within the person that communicate with the personal device to supply data, for example a Bluetooth pedometer device. Also, behavior data can come from sensors and/or signal sending devices that are in the environment that connect and/or send data to the personal device 150, for example a Bluetooth and/or Wifi enabled promotion device on a store shelf within the store that communicates information to the personal device.

The system makes use of all tracked data available to better target users based on, for example, the user's or group's psychographic, demographic, purchase history(s), preference(s), viewing, listening and reading habits, WOM (word-of mouth measurement) and models. For example, the system will provide accurate tracking of different TV types of groups of consumers such as:
Companions: For this group, TV is almost always on and is like a member of the family.
Media trendsetters: Early adopters of technology and new content, and also 39% multicultural.
Sports enthusiasts: Made up mostly of men, but most guys aren't classified here. This group also likes action-adventure programming.
Program passionates: Highly involved with favorite shows, and the biggest DVR time-shifters.
Surfers and streamers: Most open to watching alternative content on TV and most often using laptops or tablets to multitask while watching TV. They skew young, but include a large component of 50-plus people.
TV moderators: Those who enjoy being experts and leading others' choices.
   Additional groups will be added over time as the tracking system monitors, discovers, and/or analyzes new groups.

Any or all of the data collected from the user's personal device 150 is transmitted to mobile service provider in response to a specific trigger or at specific time intervals. The data may include a picture taken by the user of any item such as a food or a drawing, GPS locations within a mall or store, captured embedded signals, recommendations on social media, etc.

At some point, the user captures the embedded signal 125 from the embedded signal media 130 using a smart personal electronic device 150. The personal electronic device 150 may be a smart-phone, tablet, electronic glasses, watch, or other portable electronic device that incorporates sensors such as any/all of camera, microphone, and with or without credit, debit, stored value components, GPS, and transmission capability via wireless telephone, wife, Bluetooth, NFC, etc. Capture may be accomplished using a camera, and/or a microphone. For example, for a radio advertisement, the electronic device 150 may only capture the embedded signal 125 using the electronic device's microphone and for a billboard the electronic device 150 may only capture the embedded signal 125 using the electronic device's camera. However, for an embedded signal 125 within a television advertisement, then the camera and microphone of the electronic device 150 may be used in combination or separately to obtain the embedded signal 125.

The personal electronic device 150 sends captured embedded signal 125 to central database server 200 via user's mobile service provider 145 and mobile interface 140. The central database server 200 stores the selected embedded signal 125 with the user's profile within user database 185. The user's profile may include a username, a real name, an age, sex, nationality, language preference, product preferences, store preferences, etc. The information in the user profile may be entered by the user and/or learned over time based on captured embedded signals, purchases, and/or user locations.

Additionally, from the received captured embedded signal, the central database server 200 receives additional information 195, which includes at least date, time, and/or GPS location of the captured embedded signal. Alternatively or in combination, the embedded signal 125 may provide the time, date, and/or location. From the information, the central database 200 can determine that an advertisement was played on television at a specific time in a specific geographic zone. The information about which embedded signal 125 is associated with an advertisement and/or information about where and/or when the advertisement was captured may be stored in the advertisement database 190. Further, the additional information may include additional information from sensors within personal device 150 or connected to 150. For example, they may include the pace that a person is moving, the location within a store, heart rate change of user, etc. Additionally, from a user selecting an embedded signal 125 within a program, program viewership information can be parsed using demographic information about the user. Additionally, time delayed viewership can also be monitored when an embedded signal 125 is selected at a later time. This can add to viewership information on which demographics are watching at a later time.

At some point later, a user may use the coupon or promotion within the embedded signal 125 at a point of sale (POS) terminal 155. The POS terminal may be brick and mortar store and/or an internet store. Payment data 160 and embedded signal data 165 are sent to the merchant acquirer 170. The payment data 160 sent to the merchant acquirer 170 may be sent directly to the merchant acquirer 170 or via third party payment system (not shown). The embedded signal data 165 may be a coupon, promotion, or other type of discount. The embedded signal data 165 may also include user information. The merchant acquirer 170 processes the purchase and may send embedded signal data 165 to central database 200 via acquiring interface 175. The merchant acquirer 170 may also send purchase information to the central database 200. The purchase information may include item purchased, location, time, other items purchased, other items saved, and/or type of payment method. Alternatively, or in combination the user can send the purchase information from personal device 150 using email, upload, and/or scan/capture. The purchase information allows the central database server 200 to learn other items purchased by the user. The purchase information would not include any protected payment information. The payment information may be limited to type of payment, such as credit card type, gift card, debit card, or cash. The merchant acquirer 170 also may send the purchase information to the user.

The acquiring interface 175 may send a second embedded signal and/or secondary data to the user directly or via the merchant acquirer 170. The second embedded signal and/or secondary data may be based on change in purchase history of the user, to entice the user to come back soon, to provide a new similar product to the user, etc.

Additionally, tracking technology enables tracking of individual and grouped exchange, commerce and post exchange and or commerce of the system in real time or close to real time by hundreds of thousands to multimillions of personal devices because when a user selects an embedded signal 125 from a program, the analytics also can connect the user's info with the specific program that the embedded signal 125 was displayed within. The embedded signal 125 may be a song, a product within the show, a commercial, and so on. In contrast, the inferences derived from hardware measurement boxes located in a limited number of homes or other locations are limited by the number of hardware locations. Additionally, many hardware boxed cannot only tell household and not user, where most user's are specific to their own personal device 150.

Also, there is added information with the tracking technology that extends to the interaction between the personal device 150 and POS system 155 to track the user's use of the embedded signal 125 and/or response to an advertisement, product placement, etc. The tracking technology enables tracking of individual and grouped lifestyle activity including but not limited to all paid activity and or exchange, free, barter activity admissible by coupon, electronic coupon, voucher, ticket, permit and purchase information of the system in real time or close to real time by hundreds of thousands to multimillions of personal devices 150 as opposed to hardware measurement boxes located in a limited number of homes or other locations. Additional, the tracking technology enables health, fitness, entertainment, and other non-commercial user activities. The greater number of users in combination with GPS and other technologies in the personal device 150 provides a more detailed analytic picture of an item than inferences derived from a limited number of measurement boxes. For example, for a consumer product, the analytics may provide the most common store for a specific age group and/or demographic, how quickly certain users use a coupon, and over time generally how often certain demographic users use the product, and so on. The analytics can be used to create a huge number of inferences from large size groups to a single user. The tracking technology combines the interaction between the personal device 150 and the user, personal device 150 and the POS 155, the personal device and embedded signals 125, and the personal device 150 and items in the real world, whether they have an embedded signal or not.

The tracking technology enables the tracking of individual and grouped lifestyle activity in real time or close to real time by a server 200 and/or cloud server (not shown). The server 200 and/or cloud server may track interactions between any number of personal device(s) 150 to POS 155 to server 200 and/or cloud server; any data by any number personal device(s) 150 placed into the individual's secure portal within server 200 and/or cloud; and the artificial intelligence within the server 200 and/or cloud that provides continuous or almost continuous data analysis of an individual and/or group(s) to deliver ad or content for a transaction including benefit presentment and settlement and payment-to the personal device to be read by the POS. The server 200 and/or cloud server combine data to generate analytics to a user, for example in the form of a 2^{nd} coupon, and/or for companies to determine information about users buying their products or competitor's product, watching their television program or another, etc.

This system employs user interaction directly with the media streams through the smart device's 150 sensors, including “analog” capture through microphone and camera, and when available, digital capture through wireless streams such as WIFI, Bluetooth, and NFC. These digital streams can be useful for example in applications in which friends transfer media and/or coupons to each other.

When the user selects an embedded signal 125 from the media stream 130, the smart device 150 also provides, imperceptibly to (but under full agreement by) the user, an additional information stream 195 that includes data useful for analyses of the user's likely responses to commercial incentives. These data can include, for example, the time and place of broadcast, as well as related analytics such as the history of decisions resulting in the ad's placement. All such data are then associated to server 200 and linked user's history.

Similarly, when the user redeems coupons with a smart device 150 at the POS 155, specific information about that transaction (e.g., location and time, other purchases), transaction data, is also linked to the user's place in the user's database 185. The transaction data may be sent to server 200 via merchant acquirer 170 and/or the personal device 150.

The data from the additional information stream 195 and/or the transaction data are part of backbone analytics that are tracked with other data within server 200 to provide any combination of analytics requested by company and/or user. For company X, the analytics may be used to determine an advertisement was played of product Y on a specific network at a set time and may also include the demographic of who watched the program and the demographic of the users that purchased product Y in the advertisement. Additionally, Company X may also learn the demographic that watched a different program that bought product Y or the demographic that bought product Z made by company Z. The information may include competitor's information, better programs based on a certain demographic to place an advertisement, etc.

Also available for analytics, because of the frequent and often constant proximity to the user of personal devices 150 such as smart-phones, are other sensor streams that can capture useful data about the user's patterns of life and responses to specific stimuli during the user's bricks & mortar excursions (GPS, accelerometers) as well as during media consumption at home (video/audio capture of facial/voice responses). These streams can be obtained passively (unobtrusively and automatically, with the consent of the user) or by smart device-enabled user capture, selection and/or highlighting of specific items found through the course of media consumption and/or interaction with the day-to-day environment.

Additional tracking can be from:
1. User-to-user transfer/exchange of coupons/media for social network preference analyses.
2. Use of GPS, accelerometry, wife, opportunistic and/or sampled video/audio capture to determine user's location, speed, trajectory and orientation for the purpose of gathering analytics related to purchase decisions (e.g., sequence of looks within a store before decision).
3. Telestrator-based capture of found items in user's physical environment (e.g., at stores, on the street, in consumed media such as TV or print) for use in preference studies. Telestrator allows a user to draw a freehand sketch over a moving or still video image including a video/picture captured by a user. This allows limited selection of a picture with multiple items. Captured items can also be associated with user's comments (“might be good for that formal dance”) with homunculus and/or natural language understanding-based intelligent classification of captured item identity and design elements.

For example, the user information data includes associating user comments or annotations with user image and/or audio capture of objects and/or media content through the personal electronic device, with any associated user comments or annotations for use in determining user preferences.

The tracking system may be used with all media choices including all television, second screen, all radio including satellite, audio, all online, all mobile web all print, all video delivered by any technology including streaming, block based code (audio and/or video), watermarking (audio and/or video), fingerprinting, combination of watermarking and fingerprinting, combination of block based code and fingerprinting, Near Frequency Communication (NFC), SMS (Short Message Service), Point of Sale (POS) technologies, any communication to and from a hand-held device to a point of sale (POS) system, the individuals advertising commerce, exchange, Cloud server—Connected to tracking systems including ad verification systems, content verification systems, and other similar verification systems. The tracking technology may gathers a block based Ribbon® (See U.S. Pat. No. 7,676,532, U.S. Pat. No. 7,319,862, U.S. Pat. No. 7,054,637, U.S. Pat. No. 7,630,706, U.S. Pat. No. 7,240,075, and U.S. Pat. No. 8,296,314) information about individual users based on their activity, including but not limited to the media interaction, ad, content interaction and POS activity. The server 200 automatically appending a unique locator to each embedded signal, Ribbon, and/or AdPlexed message that is linked to the mobile device(s) 150. The server 200 aggregates the collected data, and presents the individualized information in a easily viewable, readable and or listenable format for interaction with any single or combinations of interactions with brands, merchants, financial services including POS and transaction processing, 1:1 individualized, individual to business, and exchange. Additionally the system may be employed in a cloud environment.

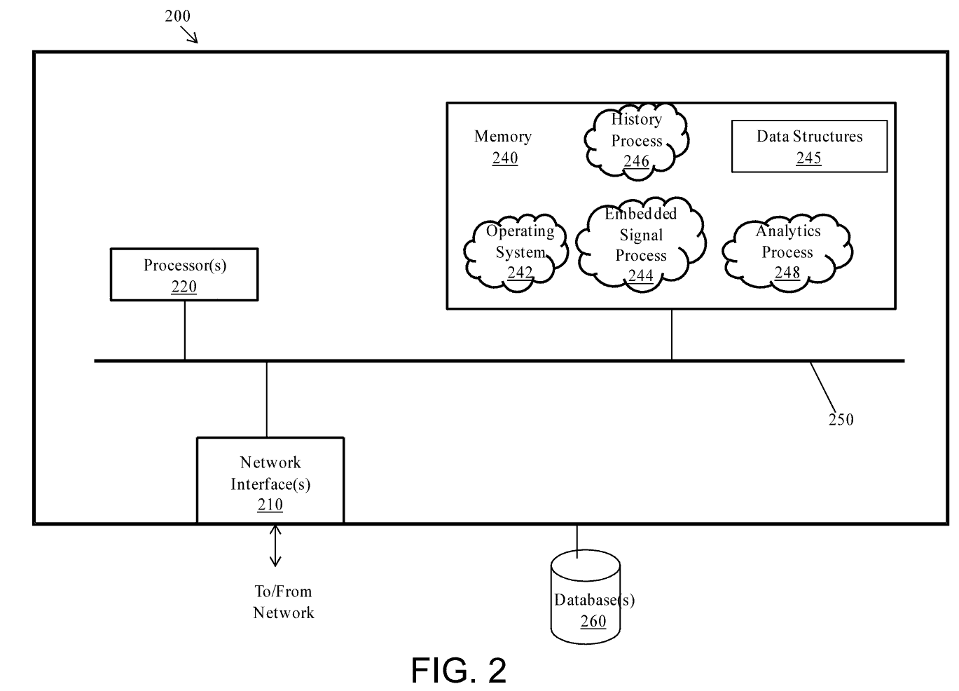

FIG. 2 is a schematic block diagram of an example server 200 that may be used with one or more embodiments described herein, e.g., as any a server shown in FIG. 1 above. The server 200 may comprise one or more network interfaces 210 (e.g., wired, wireless, etc.), at least one processor 220, and a memory 240 interconnected by a system bus 250, as well as a power supply (e.g., battery, plug-in, etc.). Additionally, or in combination server 200 may be implemented in a cloud system.

The network interface(s) 210 contain the mechanical, electrical, and signaling circuitry for communicating with mobile service provider 145, merchant acquirer, 170, and/or embedded encoder 120 (shown in FIG. 1) within network 100. The network interfaces may be configured to transmit and/or receive data using a variety of different communication protocols. Note, further, that server 200 may have two different types of network connections 210, e.g., wireless and wired/physical connections, and that the view herein is merely for illustration. Network interface(s) 210 may perform the functions of the issuing interface 135, mobile interface 140, and/or acquiring interface 175.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate data structures. An operating system 242, portions of which are typically resident in memory 240 and executed by the processor, functionally organizes the server 200 by, inter alia, invoking operations in support of software processes and/or services executing on the device. These software processes and/or services may comprise history process 246, embedding signal process 244, and/or analytics process 248, as described herein. Note that while history process 246, embedding signal process 244, and/or analytics process 248 are shown in centralized memory 240, alternative embodiments provide for the process to be specifically operated within the network interfaces 210. Another alternative uses a plurality of stand alone servers, with each server performing steps of a single process.

Illustratively, the techniques described herein may be performed by hardware, software, and/or firmware. It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Embedding signal process 244 contains computer executable instructions executed by the processor 220 to perform functions relating to the techniques herein as described in greater detail below, such as to generate one or more embedded signals and to encapsulate any additional data within the embedded signal. Further, embedding signal process 244 may store the embedded signals as data structure 247, and/or store embedded signal within database(s) 260, such as embedded signal database 180.

History process 246 contains computer executable instructions executed by the processor 220 to perform functions relating to the techniques herein as described in greater detail below, such as to receive a plurality of information about a user. The history process 246 receives information such as age, race, income, etc. from a user. Further the history process 246 also receives information from one or more sensors within the user's personal device 150. For example, the history process 246 may receive GPS locations and/or accelerometer readings from the personal device 150 to track a user's location within a store. Further, the history process 246 may receive captured images, videos, sounds, and/or embedded signals. Additionally, the history process 246 receives purchase information with regard to the user from the personal device 150 and/or the merchant acquirer 170. The history process 246 stores the information from the user within data structures 247 in memory 240 and/or in database(s) 260, such as user database 185 (See FIG. 1). Additionally, the history process 246 may determine an additional offer or coupon to send to the user based on the user's history and/or a captured image, video, sound and/or embedded signal. For example, if a user captures an embedded signal for a coupon on Pepsi®, then the history process 246 may determine based on user's demographic or prior purchase history to send a coupon for Doritos®.

Analytics process 248 contains computer executable instructions executed by the processor 220 to perform functions relating to the techniques herein as described in greater detail below, such as to generate a plurality of different inferences from the plurality of different users. The analytics process 248 determines information about users in response to purchase history relative to a specific age group or income level or sex. Additionally, the analytics process 248 determines when an embedded signal was displayed and by which users. The analytics process 248 uses the additional information 195 sent with the captured embedded signal to determine that an embedded signal was played on a specific network at a set time. The analytics process 248 may then determine which demographic of users were watching at certain time and which demographic of users who captured the embedded signal purchased the item and at which retailers. The analytics process 248 generates and determines inferences from data from database(s) 260, which include embedded signal database 180, advertisement database 190, user database 185, and/or any other database attached to server 200.

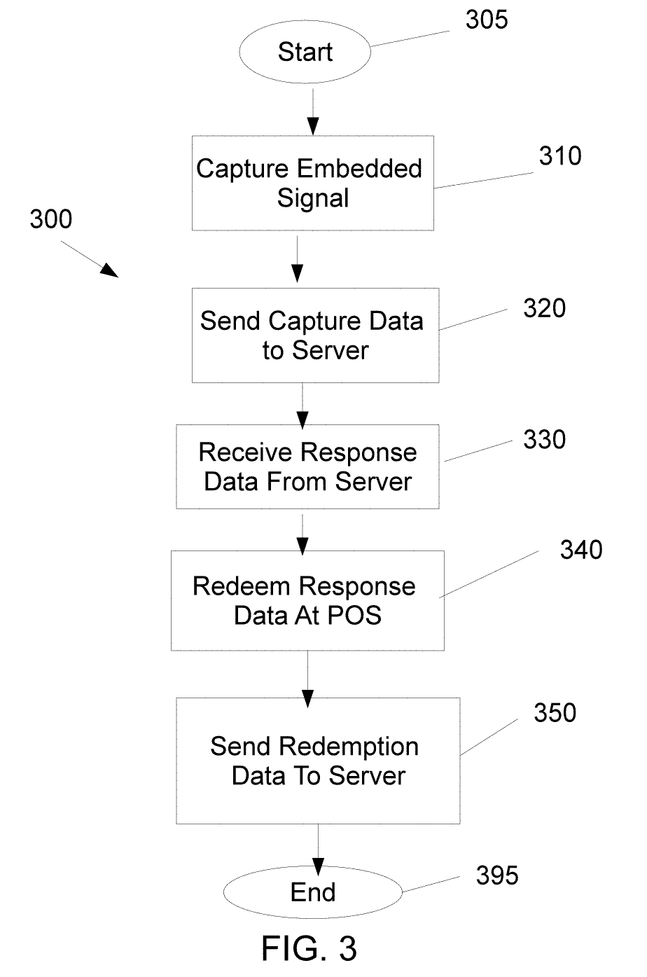

FIG. 3 illustrates an example simplified procedure 300 for a personal device to capture and use an embedded signal in network 100 in accordance with one or more embodiments described herein. The procedure 300 may start at step 305, and continues to step 310, where a user captures an embedded signal 125 using a personal device 150. The embedded signal 125 may be part of embedded signal media 130. The embedded signal media 130 may include but not limited to product placement in viewing programs, television advertisements, internet advertisements, billboards, songs or discussion in radio programs, radio advertisements, newspaper advertisements, and circulars. Additionally, the embedded signal 125 may be from social media, another user, etc. The user captures the embedded signal using video capture, speech/text interface, and gesture and/or visual selection of the items in the world.

Next at step 320, the personal device 150 sends information to server 200. The information includes the embedded signal 125 and/or additional information 195. The embedded signal and/or additional information 195 includes a time and date stamp of when embedded signal was captured and/or GPS location of captured embedded signal. Additionally, the embedded signal 125 may include other identifiers put in for example by advertisers to allow specific comparisons or to signal some other condition. Then at step 330, the personal device 150 receives information from server 200. The information may be a coupon from the embedded signal 125 and/or a coupon based on prior user history including demographic and/or purchase history,

Then at some later time, at step 340, the user redeems the coupon at a POS terminal 155. The POS may an online POS and/or a brick and mortar POS. Alternatively, the redemption may be through entering a sweepstakes or other requested information. The redemption information is sent to server 200 at step 350. The redemption information is stored with the user's profile. Additionally, the redemption information may include the store purchased at, how many purchased, any other items purchased, type of payment, loyalty/rewards card used, etc. The process may end at step 395 after step 350. Alternatively, based on redemption information the user may receive a second promotion and/or coupon.

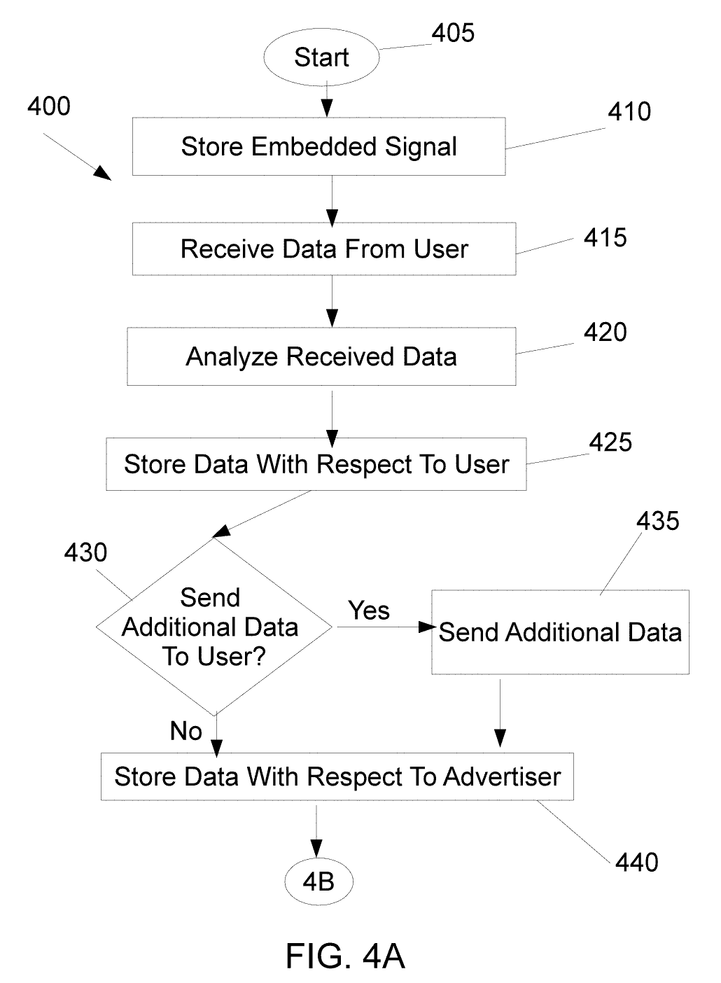

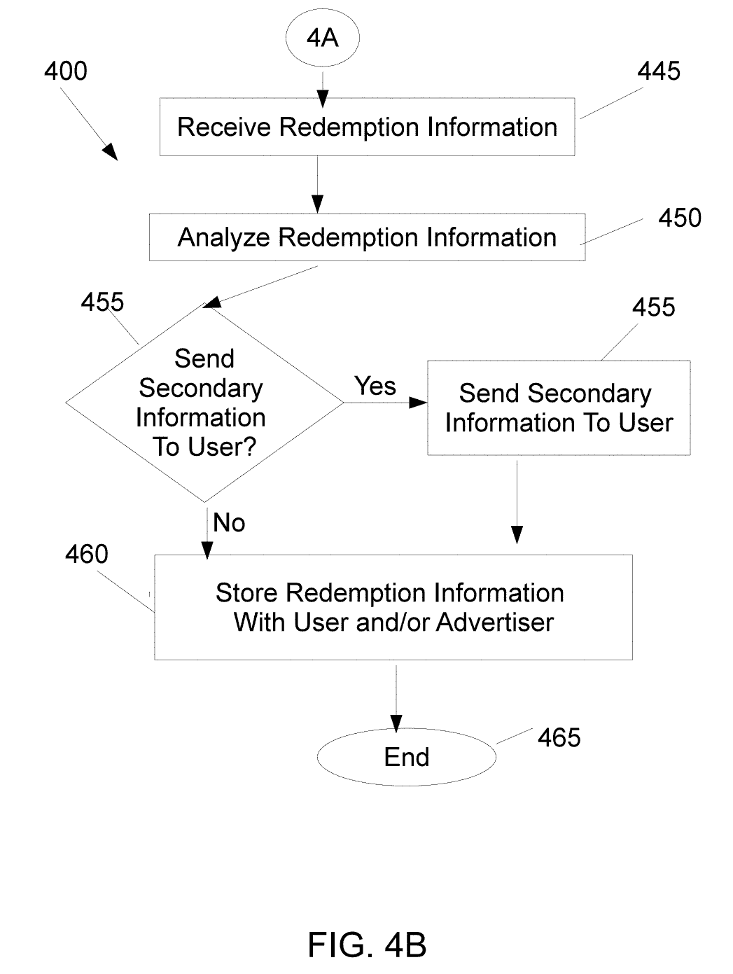

FIG. 4 illustrates an example simplified procedure 400 for server 200 to process an embedded signal 125 in network 100 in accordance with one or more embodiments described herein. The procedure 400 may start at step 405, and continues to step 410, where one or more embedded signals 125 are stored in embedded signal database 180. The embedded signal 125 may be Ribbon®, Adplex, watermark, bar code, Qwerty code, etc. Next at step 415, server 200 receives information from a personal device 150. The information may be relative to an embedded signal, any other captured item in the real world, and/or sensor information from the personal device 150. The system may include automatic content recognition of media and objects. If the information is relative to an embedded signal, then additional information 195 is also received from the personal device. The additional information 195 may include a time and date stamp, location, and any other pertinent information.

Then at step 420, the server analyzes the information and can determine information required relative to the embedded signal. For example, this may be to determine whether the user watched the program at the aired time or at a delayed time. Additionally, at step 425, the server stores any received and/or analyzed information with respect to the user. The user information may be stored in the user database 185.

Then at step 430, determine if any other information should be sent to the personal device 150. The determination may be made based on user's history of purchases and/or selected embedded codes, demographics, location, etc. Additionally or in combination, the determination may be based on an advertiser. One advertiser may want to add a bonus coupon or another advertiser may want to send a competing coupon. Also the embedded signal may be a request on its own for more information. For example, in a sports program selecting a player may give stats on that player in real or near real time during the event and/or history of the player. If server 200 determines additional information needs to be sent to the user's personal device, then at step 435 the additional information, promotion, and/or coupon is sent to the user.

Next at step 440, server 200 stores any information with respect to the advertiser. This includes any additional information 195 received the embedded signal 125. This can provide the advertiser demographic of who selected the embedded signal, when the embedded signal was selected, and/or where the embedded signal was selected.

Then at step 445, server 200 receives redemption information from merchant acquirer 170 and/or personal device 150. The redemption information may include when and where the item was purchased, and other items purchased at the same time, the price paid for each item, loyalty/rewards card used, and/or method of payment. Next at step 450, server 200 analyzes the redemption information. The analyzed redemption information provides different inference from received redemption information from one and/or multiple users. Additionally, the analyzed redemption information is specific to the user to determine if any secondary information needs to be sent to the user. This secondary information may be a bonus coupon or promotion from the manufacturer or a related product the user may like. Also the secondary information may be music video of a song or CD purchased or a user's manual for the item purchased, etc. If at step 455, server 200 determines secondary information needs to be sent to the personal device 150, then at step 460 the secondary information is sent to the user's personal device 150.

At step 465, the redemption information and/or analyzed redemption information is stored in the appropriate database. Redemption information and/or analyzed redemption information relative to the user is stored in the user database 185 and redemption information and/or analyzed redemption information relative to advertiser is stored in the advertiser database. The process 400 then ends at step 470 until more information is received from personal device 150.

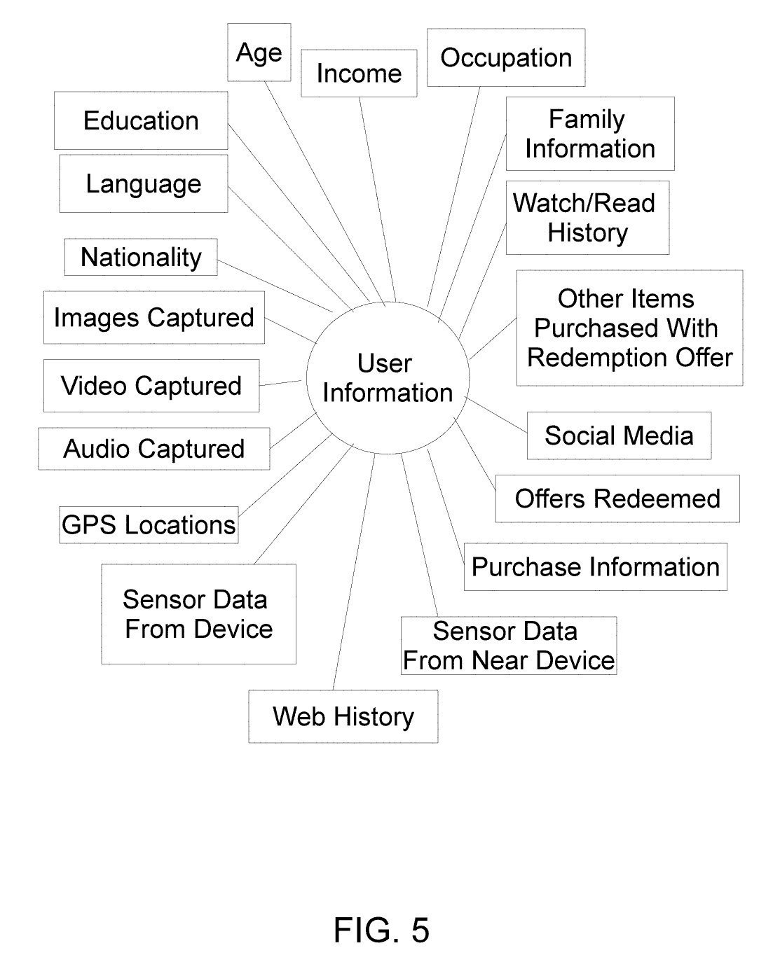

FIG. 5 illustrates an example of possible stored history information for a user in accordance with one or more embodiments described herein. The user history information of each user is controlled by the user in selecting which information the user wants to submit to server 200. The user history information may include but not limited to nationality, education, language, income level, age, occupation, family information, hometown, etc. Also, the user history information may include any item in the real world that is captured through camera and/or microphone. The user history information may save the captured real image and/or an analyzed image.

Additionally, the user history information may include GPS location from the GPS sensor and/or accelerometer or from any other location sensor in the personal device. This allows the user history information to know or learn location of user's home, location in real or near real time, event locations attended such as concerts and/or sporting events. Also, which stores the user entered and with additional information from retailers can locate which sections of a store the user spends any or most of their time.

The user history information may also include television/internet, radio watch history. Based on selected embedded signals within a television, streaming, and/or radio program, the server 200 can analyze to determine what program the embedded signal was within and store the program within the user's user history information.

The user information also includes embedded signals captured, embedded signals and/or offers redeemed. Additionally, the user information may also include other items purchased with redemption offer.

Furthermore, the user history information may include browser search history, items stored in an online cart, social media information. The social media information may include pinned items from Pinterest® and/or likes from Facebook®. Additionally, the user history information may include any information from sensors within the environment and/or the user that can communicate with personal device 150.

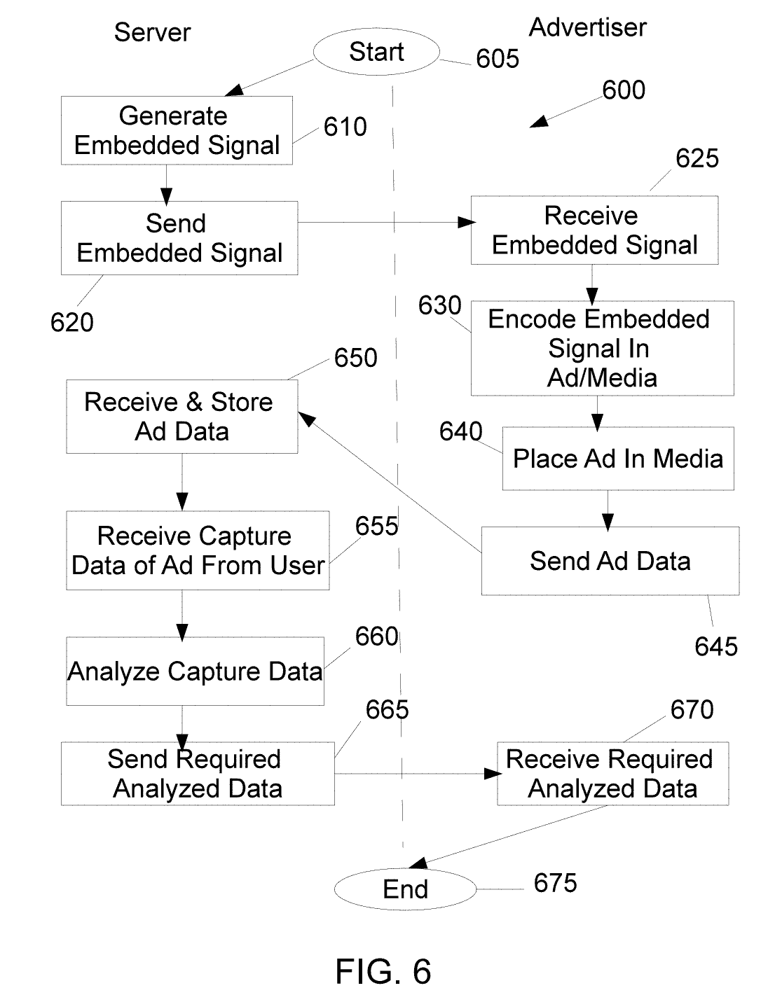

FIG. 6 illustrates an example simplified procedure 600 for tracking an embedded signal 125 in an advertisement in network 100 in accordance with one or more embodiments described herein. The procedure 600 may start at step 605, and continues to step 610, where server 200 generates one or more embedded signals 125. Next at step 620, the embedded signals are sent to the product advertisers, content providers, and/or service companies. Then at step 625, the product advertisers, content providers, and/or service companies receive the embedded signal. Then at step 630 the embedded signal 125 is placed within an advertisement or other form of media. Next at step 640, the advertisement is placed in media. For example, the advertisement may be played during a radio commercial, on a billboard, in a newspaper circular, within a streaming program, and/or within a television program. Alternatively or in combination, the embedded signal may be incorporated into media without being part of an advertisement as information within a program and/or product placement within a video or audio stream. Next at step 645, advertisement data is sent to server 200. The advertisement data may include location(s) of advertisement, type(s) of media, company name, product type, etc.

At step 650, server 200 receives the advertisement data. At step 655, server 200 receives capture data, which includes the embedded signal 125 and/or additional information 195 from a user. Next at step 660, the captured data is analyzed. The captured data is analyzed to determine information requested by the product advertisers, content providers, and/or service companies. For example, analyzing may provide that the advertisement was within a certain program at a specific time in a specific location. Alternatively, or in combination, the analyzing provides user demographics of a plurality of users that selected on the embedded signal. If the embedded signal is in multiple locations, analyzing can provide demographics for each location and/or time of an embedded signal. Also after redemption information is received, redemption information may be added to the analyzed data. Then at step 665, the requested analyzed data is sent to the product advertisers, content providers, and/or service companies. The process 600 ends at step 675, after the product advertisers, content providers, and/or service companies receive the requested analyzed data.

It should be noted that while certain steps within procedures 300-400 and 600 may be optional as described above, the steps shown in FIGS. 3-4, and 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 300-400 and 600 are described separately, certain steps from each procedure may be incorporated into each other procedure, and the procedures are not meant to be mutually exclusive.

The techniques described herein, therefore, provide receiving and analyzing data from users. In particular, the techniques provide embedded signals for any media and track usage relative of embedded signals. The techniques may also analyze embedded signals to determine inferences about users and/or embedded signals.

While there have been shown and described illustrative embodiments that provide for providing and tracking embedded signals using a user's personal device, it is to be understood that various other adaptations and modifications may be made within the spirit and scope of the embodiments herein. For example, the embodiments have been shown and described herein with relation to user's personal device. However, the embodiments in their broader sense are not as limited, and may, in fact, be used with any other types of electronic devices such as a desktop computer.

The foregoing description has been directed to specific embodiments. It will be apparent; however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A server, comprising:
an interface configured to receive user information data from a personal electronic device, wherein the user information data includes information about a user using the personal electronic device;
a user database configured to store the user information data;
the interface further configured to receive action data from the personal electronic device, wherein the action data includes information relating to an object captured through the personal electronic device; and
a processor configured to generate a first set of data based on the user information data and the action data.

2. The server according to claim 1, further comprising:
the interface further configured to receive buyer data from a point of sale system or the personal electronic device, wherein the buyer data relates to the captured object; and
the processor further configured to generate a second set of data based on the user information data, the action data, and the buyer data.

3. The server according to claim 2, wherein the user database is further configured to store buyer data and user information data to create history data of a user.

4. The server according to claim 2, wherein the processor is further configured to determine changes in buying habits for new promotions.

5. The server according to claim 1, wherein the interface is further configured to send promotion data to the personal electronic device, wherein the promotion data is based on at least one of user's history, location, or the object captured.

6. The server according to claim 1, wherein the captured object is an encoded watermark, barcode, QWERTY code, fingerprint, and/or Ribbon within an advertisement, and the advertisement is in a printed publication, a television advertisement, a computer advertisement, a billboard, and/or a radio advertisement.

7. The server according to claim 1, wherein the user information data includes media consumption habits as determined by automatic content recognition through the user's personal electronic device.

8. The server according to claim 1, wherein the user information data includes activity analysis as determined through one or more of the sensors on the user's personal electronic device, including at least one of GPS, accelerometry, wife, or opportunistic video/audio capture of the ambient environment.

9. The server according to claim 1, wherein the user information data includes associating user comments or annotations with user image and/or audio capture of objects and/or media content through the personal electronic device.

10. The server according to claim 1, wherein the processor is configured to determine personal fitness progress verse goals, and/or other personal wellness information.

11. A server, comprising:
a mobile interface configured to receive user information data from a personal electronic device;
an issuing interface configured to receive advertisement data;
a user database configured to store user information;
the mobile interface is further configured to receive action data from the personal electronic device when the personal electronic device captures the advertisement data;
means for receiving redemption data, wherein the redemption data relates to the advertisement data; and
the user database is further configured to store user information with action data and redemption data.

12. The server according to claim 11, wherein the acquiring interface receives redemption data and/or action data sent from the personal electronic device.

13. The server according to claim 12, wherein the personal electronic device scans, captures, and/or automatically detects a receipt.

14. The server according to claim 11, wherein the advertisement data is delivered by television, billboard, printed publication, computer, or a second personal electronic device.

15. The server according to claim 11, wherein the means for receiving is the mobile interface or an acquiring interface.

16. The server according to claim 11, wherein the advertisement data is an embedded signal and includes an encoded watermark, fingerprint, barcode, QWERTY, and/or Ribbon in an advertisement.

17. The server according to claim 11, further comprising an advertisement database configured to store advertisement data.

18. The server according to claim 11, wherein the advertisement data includes data from a product advertiser, a content provider, and/or a service company.

19. The server according to claim 11, wherein the mobile interface is further configured to send a second advertisement to the personal electronic device in response to receiving action data from the personal electronic device, wherein the second advertisement is based on at least one of user information, user history, or action data.

20. The server according to claim 11, further comprising a processor configured to correlate user data with action data to generate a plurality of sets of data.

21. The server according to claim 20, wherein the processor parses the action data for an embedded signal encoded within a television advertisement to generate data that the advertisement played at the correct time, and correlates the user data to show a user within a certain age group and ethnicity watched a certain television show.

22. The server according to claim 11, wherein the means for receiving redemption data includes a point of sale system used to sell an item in advertisement data.

23. The server according to claim 22, wherein the point of sale system is a brick and mortar store or an online retailer.

24. The server according to claim 16, wherein the acquiring interface receives payment data and embedded signal data from a merchant, wherein the payment data can include type of payment, but does not include credit card numbers, and the embedded signal data includes the advertisement data and purchase information data.

25. The server according to claim 11, wherein the mobile interface is further configured to receive purchase information data and the user database to store the purchase information data, wherein the purchase information data is a purchase transaction with respect to the advertisement data.

26. The server according to claim 11, wherein the mobile interface is configured to receive transfer data about advertisement passed to or from a second personal electronic device.

27. The server according to claim 11, wherein the mobile interface is further configured to receive location information from the personal electronic device and to send a reminder about stored advertisement data or send a targeted promotion based on user's history and location within a competing store or specified store.

28. A server, comprising:
an interface configured to provide an embedded signal;
an embedded signal database configured to store the embedded signal and advertisement data;
the interface further configured to receive from a personal electronic device at least one of information data about a user, a captured embedded signal, or redemption data;
a user database configured to store user information data, captured embedded signals, and/or redemption data.

29. The server according to claim 28, further comprising:
a processor configured to generate a set of metric data based on a single user or a plurality of users by parsing information about when, who, and where the embedded signal is captured.

30. The server according to claim 30, wherein the processor is further configured to determine if a second embedded signal is sent to the user based on at least one of the user information data, previous captured embedded signals, previous locations, or previous purchase history.

31. The server according to claim 28, wherein interface is further configured to receive from a merchant at least one of payment data or embedded signal data when the user redeems the embedded signal with the merchant.

32. The server according to claim 28, wherein interface is further configured to receive from the personal electronic device at least one of payment data or embedded signal data in response to the user redeeming the embedded signal with a merchant.

33. A method, comprising:
receiving user information data from a personal electronic device, wherein the user information data includes information about a user using the personal electronic device;
storing the user information data; and
receiving action data from the personal electronic device, wherein the action data includes information relating to an object captured through the personal electronic device.

34. The method according to claim 33, further comprising analyzing the object captured.

35. The method of claim 34, further comprising using automatic content recognition to analyze the object.

36. The method of claim 34, further comprising using user comments and/or annotations to analyze the object.

37. The method of claim 34, further comprising reading an embedded signal within the captured object to analyze the captured object.

38. The method according to claim 33, further comprising:
generating a first set of data based on the user information data and the action data; and
receiving buyer data from a point of sale system or the personal electronic device, wherein the buyer data relates to the captured object.

39. The method according to claim 33, further comprises generating a second set of data based on the user information data, the action data, and the buyer data.

40. The method according to claim 33, further comprising storing buyer data and user information data to create history data of a user.

41. The method according to claim 33, further comprising determining changes in buying habits for new promotions.

42. The method according to claim 41, further comprising sending promotion data to the personal electronic device, wherein the promotion data is based on at least one of user's history, location, or the object captured.

43. The method according to claim 33, wherein the captured object is an embedded signal and includes at least one of encoded watermark, barcode, fingerprint, Qwerty, or Ribbon within an advertisement, and the advertisement is in a printed publication, a television advertisement, a computer advertisement, a billboard, and/or a radio advertisement.

44. The method according to claim 33, wherein the captured object is an embedded signal and includes at least one of encoded watermark, barcode, fingerprint, Qwerty, or Ribbon within a streamed video, audio, television program, magazine publication, newspaper publication, from another device, and/or billboard.

45. A method, comprising:
sending an embedded signal;
receiving capture data from a personal electronic device when the personal electronic device captures the embedded signal; and
receiving redemption data, wherein the redemption data relates to the embedded signal.

46. The method according to claim 45, further comprising:
receiving user information data from the personal electronic device; and
storing user information.

47. The method according to claim 46, further comprising:
storing capture data and redemption data with user information

48. The method according to claim 47, wherein the capture data includes a copy of the embedded signal.

49. The method according to claim 47, wherein the capture data includes a copy of the embedded signal and additional information.

50. The method according to claim 49, wherein the additional information includes a time and date stamp of the embedded signal.

51. The method according to claim 50, wherein the additional information includes a time and date stamp and location information.

52. The method according to claim 51, further comprising determining if advertisement was properly placed based on received capture data.

53. The method according to claim 52, further comprising
receiving user information from a plurality of users;
receiving capture data from a plurality of users of the embedded signal, wherein the embedded signal is incorporated within media; and
determining demographics of media.

54. The method according to claim 52, further comprising
receiving user information from a plurality of users;
receiving capture data from a plurality of users of the embedded signal, wherein the embedded signal is incorporated within more than one type of media; and
determining demographics of media with respect to each type of media.

55. The method according to claim 52, further comprising
receiving user information from a plurality of users;
receiving capture data from a plurality of users of the embedded signal, wherein the embedded signal is incorporated within media in different locations, programs, channels, and/or times; and
determining demographics of media with respect to different locations, programs, channels, and/or times.

56. The method according to claim 47, further comprising:
receiving sensor information for a user from one or more sensors within the personal electronic device and/or connected to the personal electronic device.

57. The method according to claim 56, further comprising:
receiving user demographic information;
storing user demographic information in user history;
storing sensor information in user history; and
storing capture data in user history.

58. The method according to claim 57, further comprising:
receiving redemption information with respect to embedded signal in capture data when an item from the embedded signal is purchased; and
storing redemption information in user history.

59. The method according to claim 58, wherein the redemption information includes at least one of item purchased, other items purchased at the same time, rewards/loyalty card used, other coupons/promotions used, location of store, name of store, or method of payment.

60. The method according to claim 59, further comprising:
determining if any secondary information is sent to the user; and
in response to determining secondary information should be sent to user, sending secondary information to the user's personal electronic device.

61. The method according to claim 60, wherein the determination is based on at least one of user's demographic information, user's purchase history, user's sensor information, or advertiser requirements.

62. The method according to claim 60, wherein the secondary information is at least one of a coupon/promotion by the manufacturer of the item bought, a coupon/promotion by a competitor of the item purchased, coupon/promotion from advertiser based on item and demographics of user, coupon/promotion from advertiser based prior purchase history, or information about the item.

63. The method according to claim 47, wherein the embedded signal is an encoded watermark, barcode, fingerprint, Qwerty, and/or Ribbon in an advertisement.
